(19) United States
(12) Patent Application Publication
(10) Pub. No.: US 2017/0135515 A1
(43) Pub. Date: May 18, 2017

(54) BEVERAGE PREPARATION APPARATUS

(71) Applicant: JURA Elektroapparate AG, Oberbuchsiten (CH)

(72) Inventor: Philipp BUETTIKER, Oberbuchsiten (CH)

(73) Assignee: JURA Elektroapparate AG, Oberbuchsiten (CH)

(21) Appl. No.: 15/341,163

(22) Filed: Nov. 2, 2016

(30) Foreign Application Priority Data
Nov. 13, 2015 (EP) 15405073.6

(51) Int. Cl. A47J 31/00; C02F 5/00; A23F 5/26; A47J 31/60; A47J 31/54

(52) U.S. Cl. CPC A47J 31/002; A47J 31/60; A47J 31/54; A23F 5/26; C02F 5/00

(57) ABSTRACT

A beverage preparation apparatus, in particular coffee machine, comprising a process stage designed to convey and to heat supplied water and to dispense a prepared fluid. The process stage has a heater for heating the supplied water to a first target temperature or a second target temperature, which is different from the first target temperature, and also a path selection device for selectively choosing a direct path for the conveyed water or a softening path comprising a process stage softening device for the conveyed water. The path selection device is designed to choose the softening path when the heater heats the supplied water to the first target temperature. The path selection device is designed to choose the direct path when the heater heats the supplied water to the second target temperature.

### CROSS REFERENCE TO RELATED APPLICATIONS

Applicant claims priority under 35 U.S.C. §119 of European Application No. 15405073.6 filed Nov. 13, 2015, the disclosure of which is incorporated by reference.

### BACKGROUND OF THE INVENTION

The present invention relates to a beverage preparation apparatus, in particular a coffee machine, comprising a process stage designed to convey and to heat supplied water and to dispense a prepared fluid. The invention additionally relates to the use of a process stage designed to convey and to heat supplied water and to dispense a prepared fluid in a beverage preparation apparatus. The invention also relates to a method for operating a beverage preparation apparatus comprising a process stage of this type.

Beverage preparation apparatuses, for example coffee machines, in particular fully automatic coffee machines, are designed in many cases so that different types of products can be prepared therewith. By way of example, coffee machines are known which are suitable for preparing coffee in a coffee brewing unit and additionally for dispensing hot water at a hot water outlet and/or steam at a steam outlet.

On the one hand, the products to be produced should be tasty, faultless and physiologically compatible. On the other hand, adverse effects of a technical nature, such as the build-up of limescale and the like, should be avoided to the greatest possible extent. For taste reasons, water having a relatively low carbonate hardness (“soft water”) is often preferred for the preparation. This can also help to reduce the aforesaid limescale build-up, since this is attributed in part to the presence of hydrogen carbonate (HCO₃⁻) and other so-called hardness-causing substances in the water. The hardness-causing substances also include, for example, alkaline earth metal ions such as Mg²⁺ and Ca²⁺, which for example are bound to carbonate ions and are present as magnesium carbonate or as calcium carbonate.

In addition to the carbonate hardness, what is known as the non-carbonate hardness or permanent hardness also contributes to the overall hardness of the water. The ions present in the non-carbonate hardness of the water are not bound to hydrogen carbonate.

In order to reduce the carbonate hardness, softening devices are often used, for example in cartridge form on the basis of an ion exchange resin. Drinking water which for example is filled into a water container of the beverage preparation apparatus is supplied to the softening device as the product is being dispensed, and the hardness-causing ions are exchanged for ions, for example for Na⁺ ions, which do not tend to separate and form limescale. The hardness of the water is thus reduced.

With regard to specific ion types, heavily deionised water can lead to adverse physiological effects. In addition, an excessively low water hardness is not desirable for certain products that are to be produced, and instead the ion concentration should lie in a range between a lower limit and an upper limit. The quality of a hot beverage to be prepared is thus dependent on the water composition, among other things on a concentration of hardness-causing ions in a specific range.

Beverage preparation apparatuses having a softening device that is permanently provided in a water container are known from the prior art. WO 2014/032195 A1 discloses an apparatus for providing liquid for an automatic beverage machine comprising a filter which has a filter insert in the form of an ion exchanger. At least some of the water flowing through the filter is deionised and in this way decalcified.

EP 1 498 060 B1 discloses a filter cartridge having a plurality of filter chambers, wherein a liquid flows through all filter chambers. The filter cartridge serves to soften water removed from a water container and used to brew ground coffee.

WO 2006/079500 A1 discloses a method for controlling the water inflow to a coffee machine provided with an ion exchanger device. In the conventional method the maximum amount of water which may flow through the ion exchanger device until this is expected to be exhausted is determined. When the maximum amount of water is reached, the conventional method makes provision to bypass the ion exchanger device for the water inflow to the coffee machine.

The previously known solutions have the disadvantage that, due to be hardness-causing ions, which, although reduced in concentration might still be present, the beverage preparation apparatus continues to be subject to calcification.

### SUMMARY OF THE INVENTION

The object of the invention is to avoid the above-mentioned disadvantages and to specify a beverage preparation apparatus which dispenses physiologically compatible products on the basis of the water hardness, and with which the tendency for limescale build-up is reduced.

The object is achieved by a beverage preparation device having a process stage according to the features of claim 1. The use of a process stage in a beverage preparation apparatus and a method for operating a beverage preparation apparatus comprising a process stage also form part of this disclosure.

In accordance with one aspect of the invention, a beverage preparation apparatus has a process stage designed to convey and to heat supplied water and to dispense a prepared fluid. The process stage has a heater for heating the supplied water to either a first target temperature or a second target temperature, which is different from the first target temperature, and also a path selection device for selectively choosing a direct path for the conveyed water or a softening path comprising a process stage softening device for the conveyed water, wherein the path selection device is designed to choose the softening path when the heater heats the supplied water to the first target temperature, and wherein the path selection device is designed to choose the direct path when the heater heats the supplied water to the second target temperature.

In particular, either the direct path or the softening path can be chosen. The selection can be made automatically, for example in a fully automatic coffee machine, or can be made manually. The selection can be made for example each time a product is dispensed, for example for each brewing process of a beverage to be brewed, for example coffee, or for each steam dispensing process, or the like. The selection can also be switched during product dispensing, that is to say the selection can be switched between the direct path and the softening path during product dispensing.

The water conveyed through the process stage can also be guided selectively either directly to the outlet of the process stage, or can be guided via a process stage softening device to the outlet of the process stage. This is dependent on which of the target temperatures the conveyed water within the process stage is heated to or will be heated to.

The terms “first target temperature” and “second target temperature” do not imply any limitation to just these two target temperatures; rather, further target temperatures can also be provided.

The softening devices specified herein can be arbitrarily embodied and for example can comprise one or more of the following softening means, although this list is not limiting:

cation exchanger resin;

anion exchanger resin;

cation exchanger membrane;

anion exchanger membrane;

sheet silicate;

zeolite.

The first and the second target temperature of the process stage are predefined or can be predefined. The target temperatures specify a target value of the temperature for the fluid to be prepared. The target temperatures can also be target temperature ranges, which for example span 10 K or 5 K. The first and second target temperature ranges, which are different from one another, preferably do not overlap one another. The target temperatures or target temperature ranges can be fixedly predefined values or value ranges, for example fixedly programmed values or value ranges. They can also be values or value ranges that can be set by an operator.

Here, and also hereinafter, the term “target temperature” designates a temperature that the fluid exiting the process stage should reach. The heater of the process stage is used to heat the water in the process stage to the target temperature. A corresponding target temperature is predefined or can be predefined for a specific purpose, for example for a specific product to be heated. A previously defined target temperature of this type is set as the corresponding product is prepared, and it is sought in the process stage to reach, at the outlet thereof, the set target temperature for the fluid to be prepared (exiting fluid). For this purpose, a controller can be provided for example, such as a simple control loop which controls the heater. During normal operation, the actual temperature of the exited fluid corresponds substantially to the set target temperature, or reaches this target temperature at least approximately.

The heater of the process stage is preferably arranged downstream of the path selection device. The heater is formed for example as a continuous flow heater. The term “downstream” is based in this context on the flow direction of the conveyed water, i.e. the conveyed water flows first through the path selection device and then, depending on the selected path, either through the direct path or through the softening path comprising the process stage softening device, and only then flows through the heater.

As already mentioned, the tendency for a build-up of lime and similar hardness-causing substances increases with rising fluid temperature. With a downstream arrangement of the heater after the path selection device, it can be ensured for example that, with a desired rise of the fluid temperature, those parts of the fluid system that come into contact with the fluid at the high-temperature only have contact with fluid that has already passed through the process stage softening device. This can help to reduce the limescale build-up even more effectively.

In accordance with a further aspect provision is made for the first target temperature to be higher than the second target temperature. In other words, provision is thus made in accordance with this aspect for the process stage to be designed to choose the softening path when a first target temperature is set that is higher than a second target temperature. The selection of the corresponding path is thus made on the basis of the level of the set target temperature for the fluid to be processed. The intensity of undesired deposits, for example limescale, is indirectly or directly linked to the temperature of the prepared fluid and tends to rise with increasing temperature.

Provision is thus made in accordance with one aspect for the softening path to be chosen when it is anticipated that the intensity of limescale build-up will increase due to the higher temperature of the prepared fluid. This is to be assumed for example when the temperature of the prepared fluid is above the boiling point of water. This aspect in particular also includes the consideration that the first target temperature is above the boiling point of water and that the second target temperature is below the boiling point of water.

A softening in the process stage softening device which occurs selectively at a higher temperature among different target temperatures can also help to effectively reduce the limescale build-up and to reduce wear of the process stage softening device.

In accordance with a further aspect provision is made for the prepared fluid to be gaseous at the outlet of the process stage in the case of the first target temperature and for the prepared fluid to be liquid at the outlet of the process stage in the case of the second target temperature. Although the state of matter is also dependent on the pressure of the fluid, no particularly high pressures are used in the present technical field; the pressure in this case plays only a subordinate role, and the state of matter is actually substantially dependent on the temperature (target temperature).

By way of example, a beverage outlet is provided on the beverage preparation apparatus, from which beverage outlet a hot beverage is dispensed—after an upstream brewing stage where applicable. In addition, a steam outlet is provided by way of example, from which steam is dispensed as necessary, for example in order to prepare frothed milk. In accordance with this aspect provision is thus made for the softening path to then be chosen selectively when steam is to be dispensed (the prepared fluid at the outlet of the process stage is gaseous). A softening in the process stage softening device, which occurs selectively with the preparation of steam, can help to effectively reduce the limescale build-up and to reduce wear of the process stage softening device.

In accordance with a further aspect provision is made for the beverage preparation apparatus to have a softening device arranged upstream of the process stage for the water to be supplied to the process stage.

An upstream softening device of this type can for example perform a certain basic softening of the water, as will be described in greater detail further below. The upstream softening device then also causes a reduction of the water hardness when the direct path in the process stage is selected. If, however, the softening path in the process stage is selected, the upstream softening device and the process stage softening device cooperate.

In accordance with a further aspect, provision can be made in this context for the upstream softening device to be designed to reduce the carbonate hardness of the water to be supplied to the process stage and/or the non-carbonate hardness of the water to be supplied to the process stage to more than 0 mmol/m (millimoles per liter). In accordance with this aspect, the upstream softening device is preferably designed to reduce the carbonate hardness of the water to be supplied to the process stage and/or the non-carbonate hardness of the water to be supplied to the process stage to a minimum of 0.7 mmol/l, particularly preferably to a minimum of 1.0 mmol/l. The concentrations relate to the total amount of hardness-causing ions Ca²⁺ and Mg²⁺.

The upstream softening device in accordance with this aspect carries out a partial softening of the water which will be fed or is fed to the process stage. The term “partial softening” is understood here to mean that one or more ion types acting as hardness-causing substances in the water to be supplied are reduced in part, for example by ion exchange.

A partial softening of this type can be performed for example in that the upstream softening device guides some of the water supplied to the process stage through a softening-active region and does not guide another (generally smaller) proportion of the water through the softening-active region, but conducts this past said region. Other solutions for partial softening, however, are also conceivable.

In accordance with this aspect water that has been subject to basic softening can always be provided at the inlet of the process stage and can be used for example in a normal beverage preparation process. Water having a carbonate hardness or a non-carbonate hardness of more than 0 mmol/l is generally physiologically well suited for the preparation of beverages, in particular of hot beverages, such as tea. Because a partial softening has already been performed, the produced beverage is also advantageous in terms of taste. Deposits of lime and the like are also reduced in the partially softened water, in particular at an appropriate fluid temperature below the steam range.

Alternatively or additionally, provision can be made in accordance with a further aspect for the process stage softening device to be designed to reduce the carbonate hardness of the fluid exiting the process stage and/or the non-carbonate hardness of the fluid exiting the process stage to less than 0.7 mmol/l (millimoles per litre). Provision is preferably made for the process stage softening device to be designed to reduce the carbonate hardness of the fluid exiting the process stage and/or the non-carbonate hardness of the fluid exiting the process stage to substantially 0 mmol/. The concentrations relate to the total amount of the hardness-causing substances Ca²⁺ and Mg²⁺.

In accordance with the hardness scale conventional in Switzerland, water having a proportion of Ca²⁺ ions and Mg²⁺ ions in a range below 0.7 mmol/l is defined as “very soft” water. Very soft water of this type might not be well-suited for the preparation of specific hot beverages, such as coffee or tea. This can be due to taste reasons, since it is believed that a certain concentration range of the specified ions above the specified concentrations and below a maximum concentration (not defined here in greater detail) is optimal, i.e. a certain minimum of the specified ions should be present in the brewing water. On the other hand, however, it may also be advisable for physiological reasons to provide a certain minimum of the specified ions.

Very soft water of this type, however, is outstandingly suitable for other applications, for example for steam, which is used to produce frothed milk or the like. Particularly at the high temperatures necessary to dispense steam, the use of very soft water of this type is additionally advantageous, since limescale build-up can be effectively reduced thereby.

In accordance with this aspect, which can be combined particularly advantageously with the aspect in accordance with which the upstream softening device performs a certain basic softening above 0 mmol/l of hardness-causing ions, a substantially complete softening of the fluid to be dispensed is thus advantageously performed when the taste-based and physiological preconditions for a substantially complete softening of this type are present, whereby limescale build-up can be effectively reduced.

In accordance with a further aspect provision is made for the upstream softening device to be arranged in or on a water container of the beverage preparation device. Alternatively or additionally, provision can be made for a softening-active part of the upstream softening device to be exchangeable and/or regenerable. A softening-active part of this type can, in fact, relate only to a physical region of the upstream softening device, which then is exchangeable and/or regenerable. However, it is also possible for the entire upstream softening device to form the softening-active part and to be exchangeable and/or regenerable.

An example of an exchangeable softening device is one based on a casing or cartridge and having a specific softening power, wherein the casing or cartridge is replaced after a certain amount of water has been conveyed therethrough and/or after a certain period of time has elapsed. Additional filters can also be incorporated in a softening casing/softening cartridge, for example activated carbon filters or similar. A regenerable softening device can for example provide a chemical regeneration, for example by sodium chloride treatment, with which hardness-causing ions accumulated at an ion exchanger medium are displaced by Na⁺ ions.

In accordance with a further aspect provision is made for the process stage softening device to be integrated in the process stage in a maintenance-free manner for the service life of the beverage preparation apparatus. A fixed installation of this type is user-friendly, since an operator does not have to be tasked with a potentially complicated replacement process. An integrated process stage softening device can be arranged at a technically advantageous point in the beverage preparation apparatus. The anticipated service life of the beverage preparation apparatus is fixed at the time of design of the appliance; the decalcifying capacity to be provided for the process stage softening device is oriented towards this.

Alternatively, however, provision can also be made in accordance with a further aspect for a softening-active part of the process stage softening device to be exchangeable and/or regenerable. A softening-active part of this type can, in fact, relate only to a physical region of the process stage softening device, which is then exchangeable and/or regenerable. However, it is also possible for the entire process stage softening device to form the softening-active part and to be exchangeable and/or regenerable.

In accordance with a further aspect provision is made for the beverage preparation apparatus to allow an operator to select a product to be processed or a product sequence to be processed from a number of products each having a different beverage temperature of the exiting fluid. The beverage preparation apparatus is designed in accordance with this aspect to specify, for the process stage, either the first target temperature or the second target temperature depending on the beverage temperature. The specification of the first target temperature or of the second target temperature at the process stage can also be changed during the dispensing of a product to be prepared or during the dispensing of a product sequence to be prepared; in other words: it is also possible to switch between the direct path or the softening path during the dispensing of a product to be prepared or during the dispensing of a product sequence to be prepared.

The product selection is preferably made fully automatically or semi-automatically, for example in a fully automatic coffee machine. Selectable products can be coffee, espresso, cappuccino, café latte, milk froth, and steam, for example. By way of example, provision can be made for the fluid in the process stage to be prepared at a comparatively low brewing temperature (for example approximately 85° C. or approximately 90° C. or at a temperature below the boiling point of water) when a coffee product or a coffee base product (for example espresso for a cappuccino) is selected. With a previous or subsequent dispensing of steam (for manually producing milk froth) or milk froth (automatically produced), for example in conjunction with a selected product sequence, the fluid in the process stage is prepared at a higher temperature (for example >100° C. or at a temperature above the boiling point of water). At the lower brewing temperature, the direct path can then be selected for example, and at the higher temperature for steam generation the softening path can be selected.

In accordance with a further aspect, the beverage preparation device also has a signalling device, which is designed to determine whether a criterion for exchanging and/or regenerating the upstream softening device is met. When it is determined that the criterion is met, a corresponding signal is output, for example to an operator.

Alternatively or additionally, provision can be made for the signalling device to be designed to determine whether a criterion for exchanging and/or regenerating the process stage softening device is met. When it is determined that the criterion is met, a corresponding signal is output, for example to an operator.

In accordance with a further aspect, the beverage preparation apparatus is a coffee machine, in particular a fully automatic coffee machine.

A further aspect of this disclosure is directed to the use of a process stage in a beverage preparation apparatus, in particular in a coffee machine, preferably a fully automatic coffee machine, wherein the process stage is designed to convey and to heat supplied water and to dispense a prepared fluid, wherein the process stage comprises the following: a heater for heating the supplied water to either a first target temperature or a second target temperature, which is different from the first target temperature;

a path selection device for selectively choosing a direct path for the conveyed water or a softening path comprising a process stage softening device for the conveyed water. When used in a beverage preparation apparatus, the process stage is embodied in accordance with one or more of the aspects or embodiments disclosed herein.

The invention also relates to a method for operating a beverage preparation apparatus comprising a process stage, which is designed to convey and to heat supplied water and to dispense a prepared fluid, and a path selection device for selectively choosing a direct path for the conveyed water or a softening path comprising a process stage softening device for the conveyed water, wherein a heater for heating the supplied water is arranged downstream of the path selection device. In accordance with this method, the beverage preparation apparatus is operated in such a way that either the following steps (A) or the following steps (B) are carried out alternatively:
(A) choosing the softening path by means of the path selection device and conveying supplied water via the softening path to the heater, wherein the water conveyed via the softening path is softened by means of the process stage softening device and is then heated by means of the heater to a first target temperature; or
(B) choosing the direct path by means of the path selection device and conveying supplied water via the direct path to the heater, wherein the water conveyed via the direct path is heated by means of the heater to a second target temperature, wherein the second target temperature is different from the first target temperature.

In accordance with this method the direct path or the softening path is selected for the supplied water depending on the corresponding target temperature to which the water is to be heated by means of the heater. The first and the second target temperature are predefined or can be predefined.

In accordance with a further aspect of the method according to the invention, the first target temperature is higher than the second target temperature. In particular, in accordance with this aspect, the first target temperature is above the boiling point of water, and the second target temperature is below the boiling point of water.

When the second target temperature is below the boiling point of water, the water would be heated in accordance with steps (B) by means of the heater to a temperature at which the water is in a liquid state. When the first target temperature is above the boiling point of water, the water would be heated in accordance with steps (A) by means of the heater to a temperature at which the water evaporates.

Here, it is ensured that the supplied water is conveyed via the softening path of the process stage and in so doing is softened, provided the water is to be heated to a relatively high (first) target temperature (compared to another “second” target temperature), whereas the supplied water is conveyed via the direct path of the process stage (without being softened over the direct path of the process stage), provided the water is to be heated to a relatively low (second) target temperature.

### BRIEF DESCRIPTION OF THE DRAWINGS

Further details of the invention and in particular an exemplary embodiment of the device according to the invention and use according to the invention will be explained hereinafter on the basis of the accompanying drawings, in which:

FIG. 1 shows a schematic view of a beverage preparation apparatus in accordance with an embodiment of the invention.

### DETAILED DESCRIPTION OF THE EMBODIMENTS

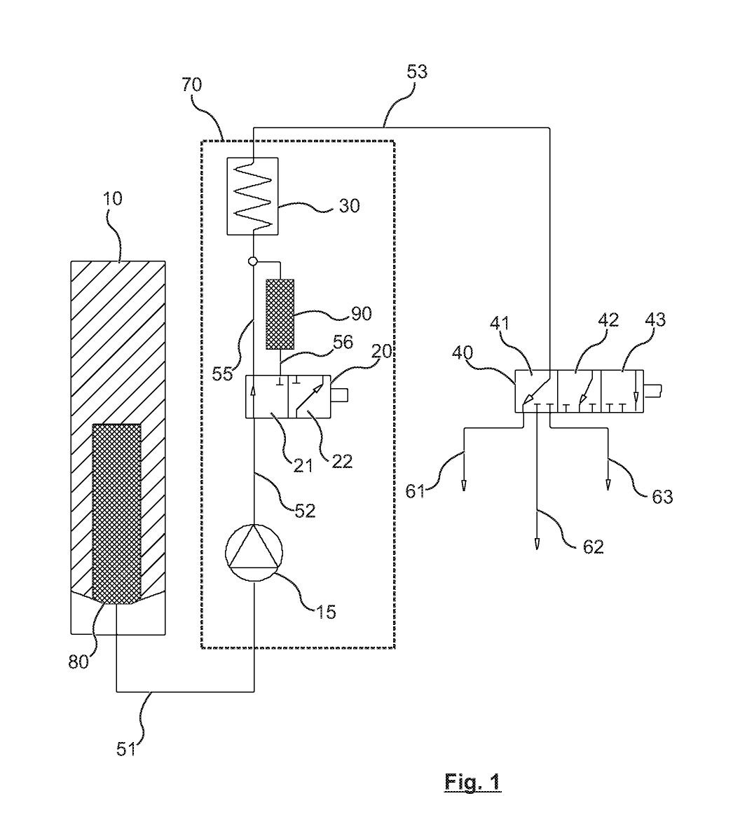

FIG. 1 illustrates a schematic view of a beverage preparation apparatus in accordance with an embodiment of the invention.

A water container 10 is connected at the outlet thereof to a pump feed line 51, which leads into a process stage 70 indicated by means of a dashed line. The water container 10 can be filled with generally cold drinking water. A feed pump 15 is provided in the process stage and conveys the water present at the inlet of the process stage 70 into a valve feed line 52. The valve feed line 52 in turn leads into a path selection device, which in the illustrated embodiment is formed specifically as a changeover valve 20 (as directional valve having an inlet, two valve stages 21, 22 and an outlet for each valve stage 21, 22). The changeover valve 20 can be controlled, for example electromagnetically, pneumatically/hydraulically, or mechanically.

In a first valve stage 21 of the changeover valve 20, a direct path 55 is connected to the valve outlet, via which path a heater 30 arranged downstream of the changeover valve 20 is directly connected to the valve feed line 52.

In a second valve stage 22 of the changeover valve, a softening path 56 is connected at the valve outlet. With regard to the flow, a process stage softening device 90 is arranged in this softening path 56 between the inlet of the heater 30 and the valve feed line 52.

A heater 30 is, in the embodiment, a controllable electric continuous flow heater, which is designed to provide an output-side fluid at least at two different target temperatures. In accordance with the described embodiment, at least one of the target temperatures is a temperature at which the output-side fluid is gaseous.

The heater 30 is connected on the outlet side to an outlet feed line 53 in order to supply the prepared fluid to an outlet device. The outlet device in accordance with the exemplary embodiment has a first outlet 61, a second outlet 62, and a third outlet 63. By way of example, the first outlet 61 leads into a brewing unit for preparing a coffee beverage, the second outlet 62 leads into a hot water dispensing device for dispensing hot water, for example for tea, and the third outlet 63 leads into a steam nozzle for frothing milk. An outlet valve 40, which is again formed as a controllable directional valve, for example controllable electromagnetically, pneumatically/hydraulically or mechanically, allows a selection of the corresponding outlet 61, 62 or 63, more specifically by means of a first valve stage 41, second valve stage 42, or third valve stage 43 of the outlet valve 40 respectively.

In the illustrated exemplary embodiment, an upstream softening device 80 is arranged in the water container 10. The upstream softening device 80 is a filter cartridge in the exemplary embodiment, which cartridge performs a partial softening (a basic softening) of the water from the water container 10. This partially softened water has a hardness suitable for preparing hot beverages that are of high quality in terms of taste.

The beverage preparation apparatus in accordance with the illustrated embodiment is designed to instruct the process stage 70 to choose the first valve stage 21 of the changeover valve 20 when a hot beverage is to be dispensed and to choose the second valve stage 22 of the changeover valve 20 when steam is to be dispensed via the third outlet 63.

When a hot beverage is dispensed, the water that runs into the process stage 70 is supplied by means of the supply pump 15 to the changeover valve 20 at the first valve stage 21. The water is accordingly conveyed via the direct path 55 to the heater 30 and is heated there to a temperature suitable for providing the hot beverage, for example a temperature ranging between 80° C. and 95° C., preferably approximately 85° C., or to a temperature below the boiling point of water. The water then passes on by means of the pump pressure via the outlet feed line to the outlet valve 40, which in the illustrated embodiment is at the first valve stage 41 when coffee is dispensed or is at the second valve stage 42 when hot water is dispensed.

When steam is dispensed, which can be initiated automatically or manually, the water that runs into the process stage 70 is again supplied by means of the supply pump 15 to the changeover valve 20, however this has now been set to the second valve stage 22. The water is conveyed accordingly via the softening path 56, in which the process stage softening device 90 is arranged. There, it is substantially completely softened, i.e. the concentration of hardness-causing ions, in particular Ca²⁺ ions and Mg²⁺ ions, lies below 0.7 mmol/l and preferably substantially at 0 mmol/l. The water is then conveyed to the heater 30 and is heated there to a temperature suitable for providing steam, for example to a temperature above 100° C. or above the boiling point of water. The water then passes on by means of the pump pressure via the outlet feed line to the outlet valve 40, which in the illustrated embodiment is at the third valve stage 43 when steam is dispensed.

Due to the substantially complete softening when dispensing steam, deposits, in particular limescale, in the heater 30 and in the system parts arranged downstream in the flow direction of the fluid to be dispensed (outlet feed line 53, outlet valve 40, outlets 61, 62, 63) can be effectively reduced. Particularly at the comparatively high pressures necessary when providing steam, the deposits would increase if just a basic decalcification were performed by means of the upstream softening device 80. At the same time, due to the selective connectability by means of the changeover valve, it is ensured that, for the preparation of hot beverages (i.e. dispensing of hot water), water having a water hardness suitable for this purpose physiologically and in terms of taste leaves the process stage.

What is claimed is:

1. A beverage preparation apparatus comprising:
a process stage designed to convey and to heat supplied water and to dispense a prepared fluid, the process stage having a heater for heating the supplied water to a first target temperature and a second target temperature, which is different from the first target temperature, and also a path selection device for selectively choosing a direct path for the conveyed water or a softening path, the softening path comprising a process stage softening device for the conveyed water,
wherein the path selection device is designed to choose the softening path when the heater heats the supplied water to the first target temperature, and wherein the path selection device is designed to choose the direct path when the heater heats the supplied water to the second target temperature.

2. The beverage preparation apparatus according to claim 1, wherein the first target temperature is higher than the second target temperature.

3. The beverage preparation apparatus according to claim 2, wherein, the process stage is configured such that when the first target temperature is selected, the prepared fluid at the outlet of the process stage is gaseous, and wherein when the second target temperature is selected, the prepared fluid at the outlet of the process stage is liquid.

4. The beverage preparation apparatus according to claim 1, further comprising a softening device upstream of the process stage for the water to be supplied to the process stage.

5. The beverage preparation apparatus according to claim 4, wherein the upstream softening device is designed to reduce the carbonate hardness of the water to be supplied to the process stage and/or the non-carbonate hardness of the water to be supplied to the process stage to more than 0 mmol/l.

6. The beverage preparation apparatus according to claim 1, wherein the process stage softening device is designed to reduce the carbonate hardness of the fluid exiting the process stage and/or the non-carbonate hardness of the fluid exiting the process stage to less than 0.7 mmol/l.

7. The beverage preparation apparatus according to claim 4, wherein the upstream softening device is arranged in or on a water container of the beverage preparation apparatus, and/or wherein a softening-active part of the upstream softening device is exchangeable or regenerable.

8. The beverage preparation apparatus according to claim 1, wherein the process stage softening device is integrated in the process stage in a maintenance-free manner for a service life of the beverage preparation apparatus.

9. The beverage preparation apparatus according to claim 1, wherein a softening-active part of the process stage softening device is exchangeable or regenerable.

10. The beverage preparation apparatus according to claim 1, wherein the beverage preparation apparatus is designed to allow an operator to select a product to be prepared or a product sequence to be prepared from a number of products each having a different beverage temperature of the fluid to be dispensed, and
wherein the beverage preparation apparatus is designed to specify, for the process stage, either the first target temperature or the second target temperature depending on the beverage temperature.

11. The beverage preparation apparatus according to claim 4, further comprising a signalling device designed to determine whether a criterion for exchanging or regenerating the upstream softening device or the process stage softening device is met, and, when it is determined that the criterion is met, to output a corresponding signal to an operator.

12. The beverage preparation apparatus according to claim 1, wherein the beverage preparation apparatus is a coffee machine.

13. A method for operating a beverage preparation apparatus, which beverage preparation apparatus comprises a process stage designed to convey and to heat supplied water and to dispense a prepared fluid, and a path selection device for selectively choosing a direct path for the conveyed water or a softening path comprising a process stage softening device for the conveyed water, wherein a heater for heating the supplied water is arranged downstream of the path selection device,
Comprising one of the following steps:
(A) choosing the softening path by the path selection device and conveying supplied water via the softening path to the heater, wherein the water conveyed via the softening path is softened by the process stage softening device and is then heated by the heater to a first target temperature; or
(B) choosing the direct path by the path selection device and conveying supplied water via the direct path to the heater, wherein the water conveyed via the direct path is heated by the heater to a second target temperature, wherein the second target temperature is different from the first target temperature.

14. The method according to claim 14, wherein the first target temperature is higher than the second target temperature.

15. The method according to claim 15, wherein the first target temperature is above the boiling point of water and the second target temperature is below the boiling point of water.
